(19) United States
(12) Patent Application Publication
(10) Pub. No.: US 2020/0239746 A1
(43) Pub. Date: Jul. 30, 2020

(54) PERFORMANCE ADHESIVE FOR SECURITY DOCUMENTS

(71) Applicant: Crane & Co., Inc., Boston, MA (US)

(72) Inventors: Nancy J. Gettens, Waban, MA (US); Gerald Nkwantah, Pepperell, MA (US); Jeffrey Scot Royal, Belchertown, MA (US); Michael McAllister, Windham, NH (US)

(21) Appl. No.: 16/775,103

(22) Filed: Jan. 28, 2020

Related U.S. Application Data
(60) Provisional application No. 62/798,992, filed on Jan. 30, 2019.

(51) Int. Cl. C09J 101/02; C09J 7/22; C09J 7/21; C09J 139/06; C09J 123/06; C09J 123/08; C09J 123/12; C09J 127/18; C09J 127/16; C09J 127/06; C09J 129/14; C09J 167/02; C09J 175/04; B42D 25/29; B42D 25/24; B42D 25/23; B42D 25/25; C09J 109/06; C09J 105/00; C09J 131/04; C09J 11/06

(52) U.S. Cl. CPC C09J 101/02; C09J 11/06; C09J 7/21; C09J 139/06; C09J 123/06; C09J 123/08; C09J 123/12; C09J 127/18; C09J 127/16; C09J 127/06; C09J 129/14; C09J 167/02; C09J 175/04; B42D 25/29; B42D 25/24; B42D 25/23; B42D 25/25; C09J 109/06; C09J 105/00; C09J 131/04; C09J 7/22

(57) ABSTRACT

An adhesive suitable for use in security documents (for example, currency, passports, tickets, etc.) includes a plurality of polymers, that collectively exhibit tackification, resistance to aqueous agents, and solvent resistance, and a cross-linker selected to be activated to chemically react with one or more polymers of the plurality of polymers, at a temperature in a predetermined range of temperatures.

### CROSS-REFERENCE TO RELATED APPLICATION AND CLAIM OF PRIORITY

This application is based on and claims priority under 35 U.S.C. §119 to U.S. Provisional Application No. 62/798,992 filed Jan. 30, 2019, the disclosure of which is incorporated by reference herein in its entirety.

### TECHNICAL FIELD

This disclosure relates generally to adhesives. More specifically, this disclosure relates to a performance adhesive for security documents.

### BACKGROUND

Certain security documents, including, without limitation, banknotes, stamps, passports, identification cards and tickets, utilize a multi-part construction, comprising one or more substrates (for example, fibrous substrates, such as paper) to which security elements, such as holograms, security threads and or micro-optic features are affixed on, or at least partially integrated into the substrate, with one or more adhesives. The components of the security document, including the features and placement of any security elements, can work cooperatively to produce multiple detectable (for example, by a viewer's eye, or by specialized machinery) indicia of the security document's authenticity.

Accordingly, the properties of the adhesives used in the manufacturing process are of vital importance to the overall effectiveness of the security document. For example, adhesives which cannot be dissolved through soaking in water or exposure to commonly available degradants (for example, oxidizers, such as hydrogen peroxide), and which do not permit the removal, or harvesting of security elements, promote the effectiveness of a security document by facilitating counterfeit resistance. Forgery and counterfeiting of security documents impose significant costs on issuers of security documents, as documents which can be disassembled for parts for forgeries need to be removed from circulation and replaced. Similarly, adhesives which yellow or otherwise break down under foreseeable environmental conditions and mechanical stresses (for example, folding, or accidentally being washed with laundry) undermine the effectiveness of the security documents of which they are a part, and impose increased retirement and replacement costs on issuers. The replacement costs imposed by forgery and wear are significant, and depending on the security document at issue (for example, currency notes) can be on the order of multiple millions of dollars per year in replacement costs.

Thus, the technical challenges associated with developing high performance adhesives for constructing security documents include, without limitation, developing adhesive compositions which reconcile competing and often seemingly incompatible performance demands (for example, the adhesive must strongly bond a security element to a paper substrate, but at the same time, comprise a thin layer) with constraints imposed by manufacturing processes (for example, time limits associated with the amount of time a moving web spends in particular stages of a paper processing machine, or temperature limits to avoid melting or damaging micro-lenses or other structures of security elements).

Historically, manufacturers of security documents have commonly chosen to use adhesives comprising thermoplastics which are water resistant, but susceptible to solvents. Heretofore, adhesives for security documents have failed to combine the water-resistant and solvent-resistant properties desired by manufacturers of security documents. Accordingly, opportunities remain for improving the overall performance of adhesives for use in security documents as a mechanism for enhancing the counterfeit resistance of security documents.

### SUMMARY

This disclosure provides a performance adhesive for security documents.

In a first embodiment, an adhesive includes a plurality of polymers, that collectively exhibit tackification, resistance to aqueous agents, and solvent resistance, and a cross-linker selected to be activated to chemically react with one or more polymers of the plurality of polymers, at a temperature in a predetermined range of temperatures.

In a second embodiment, a security document includes a paper substrate, a security device, and an adhesive layer comprising an adhesive, the adhesive layer providing a bond between the security device and the paper substrate. Further, the adhesive includes a plurality of polymers, that collectively exhibit tackification, resistance to aqueous agents, and solvent resistance, and a cross-linker selected to be activated to chemically react with one or more polymers of the plurality of polymers, at a temperature in a predetermined range of temperatures.

In a third embodiment, a method of making a security document includes, at a paper machine configured to pass a substrate containing water through one or more processing sections, introducing an adhesive to create an adhesive layer, the adhesive including a plurality of polymers that collectively exhibit tackification, resistance to aqueous agents, and solvent resistance , and a cross-linker selected to be activated to chemically react with one or more polymers of the plurality of polymers, at a temperature in a predetermined range of temperatures. The method further includes positioning a security device on a first portion of the substrate to which the adhesive has been introduced, and passing the first portion of the substrate to a processing section of the paper machine at the temperature in the predetermined range of temperatures to activate the cross-linker to chemically react with one or more polymers of the plurality of polymers. Additionally, the adhesive is introduced to the substrate at a processing section of the paper machine where the substrate contains sufficient water to activate a polymer of the plurality of polymers that exhibits tackification, to provide wet tack.

In a fourth embodiment, a security device includes a substrate, an authentication structure, and an adhesive layer which includes an adhesive, wherein the adhesive layer provides a bond between the security device and a paper substrate. Further the adhesive includes a plurality of polymers, that collectively exhibit tackification, resistance to aqueous agents, and solvent resistance, and a cross-linker selected to be activated to chemically react with one or more polymers of the plurality of polymers, at a temperature in a predetermined range of temperatures.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example of a security document comprising an adhesive according to certain embodiments of this disclosure;

FIG. 2 illustrates an example of a security device which can be affixed to a security document using adhesives according to various embodiments of this disclosure;

FIG. 3 illustrates, in schematic format, elements of a paper machine for implementing methods of making security documents according to some embodiments of this disclosure;

FIG. 4 illustrates operations of a method for manufacturing security documents according to some embodiments of this disclosure; and

FIG. 5 illustrates aspects of the composition and properties of component compounds of an adhesive according to various embodiments of this disclosure.

### DETAILED DESCRIPTION

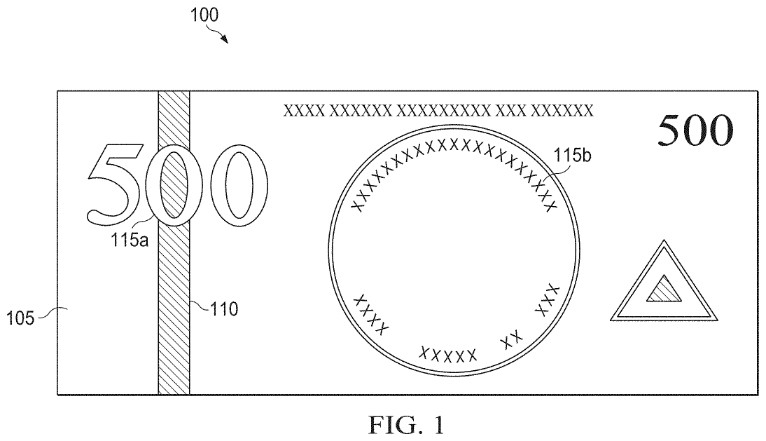

FIGS. 1 through 5, discussed below, and the various embodiments used to describe the principles of this disclosure in this patent document are by way of illustration only and should not be construed in any way to limit the scope of the disclosure.

FIG. 1 illustrates an example of a security document 100 according to this disclosure.

Referring to the non-limiting example of FIG. 1, security document 100 comprises a paper substrate 105, to which one or more security devices (for example, security thread 110) are affixed using an adhesive. According to various embodiments, the constructional details of security document 100, including, without limitation, optical effects (for example, flickering, presentation of a synthetic image, or moire effects) created by security thread 110, watermarks (for example, watermarks 115a and 115b), and precise alignment of constructional details (for example, the registration of security device through a window in the second “0” of the “500,” work cooperatively to provide detectable indicia of authenticity and to discourage forgery.

Further, in certain embodiments, security document 100 is constructed to satisfy a wide range of performance criteria (for example, performance criteria specified by central banks as well as constraints imposed by manufacturing methods suitable for producing large numbers of security documents). In certain instances, the performance criteria for security documents include performance criteria for the adhesives used to affix security devices to a paper substrate (for example, paper substrate 105) used in constructing the security document. Non-limiting, real world examples of performance criteria for adhesives to be used in a security document, such as security document 100 are set forth below.

The performance criteria for an adhesive according to various embodiments of this disclosure comprise a requirement that the adhesive affixing a security device (for example, security thread 110 in FIG. 1) be substantially transparent when dried, and that the dried adhesive layer between a paper substrate and a security device be between 2 to 10 microns in thickness.

In addition to, or as an alternative to, some or all of the above-described criteria, the performance criteria for adhesives according to some embodiments of this disclosure comprise a requirement that the adhesive not yellow when exposed to heat, or humidity or light. In some embodiments, the performance criteria for an adhesive can include a requirement that the adhesive can be pre-applied to a security feature and the security feature can be applied to a substrate containing sufficient moisture to activate the tackifying properties of the adhesive.

In some embodiments, in addition to, or as an alternative to, some or all of the above-described criteria, the criteria for use in a security document can comprise a requirement that the adhesive provide wet tack between a wet substrate and a security device in a paper machine, and permit accurate alignment (sometimes referred to as registration) of security devices with other constructional features of a security document. The performance criteria for an adhesive according to certain embodiments of this disclosure can include a requirement that the adhesive does not cause security devices to curl in a paper machine. Further, the performance criteria for various adhesives according to this disclosure may include a requirement that, on a finished security document, the adhesive remains bonded to both the paper substrate and the security device after soaking in one or more organic solvents or solutions of aqueous agents. Examples of aqueous agents, resistance to which may be included in performance criteria for an adhesive include, without limitation, acids (for example, hydrochloric acid solutions), bases (for example, solutions of sodium hydroxide) and oxidizers (for example, bleach). Examples of organic solvents, resistance to which may be included in performance criteria for an adhesive include, without limitation, toluene and acetone.

In addition to, or as an alternative to the above-discussed performance criteria, the performance criteria for adhesives according to certain embodiments of this disclosure can include requirements that, on a finished security document, the adhesive withstand common currency mechanical tests, including, without limitation, a laundry test, crumple testing, circulation simulation, Sutherland rubbing and tape testing. Performance criteria for adhesives according to some embodiments of this disclosure include, without limitation, a requirement that the adhesive can be used for security documents in which security devices (for example, micro-optic threads) are woven into a paper substrate, as well as security documents in which security devices are affixed to the exterior of the paper substrate. Still further performance criteria for adhesives according to various embodiments of this disclosure include a requirement that the adhesive preferably be able to bond to security devices and paper substrates without a primer or surface treatment.

As shown above, the properties and performance of the adhesive used in manufacturing security documents contribute significantly to the overall performance of the security document, and its ability to reliably present indicia of authenticity and stanch counterfeiting.

Surprisingly, security documents satisfying the performance requirements required by manufacturers of security documents, including combinations of the performance criteria set forth above, can be manufactured through the use of adhesives according to certain embodiments of this disclosure, which allow a polymer which exhibits resistance to aqueous agents to be used in conjunction with a polymer that exhibits solvent resistance, thereby providing manufacturers of security documents an adhesive that provides an unexpectedly durable bond between substrates and security devices. Put differently, adhesives according to various embodiments of this disclosure provide an unexpectedly strong, thin and tenacious (as used herein, the term “tenacious” encompasses the property of exhibiting good resistance to external degradants, such as aqueous agents (for example, oxidizers, acidic solutions and base solutions) as well as organic solvents) bond between a paper substrate and a security device, while at the same time, being compatible with high-volume, high-precision paper machines used for manufacturing security documents.

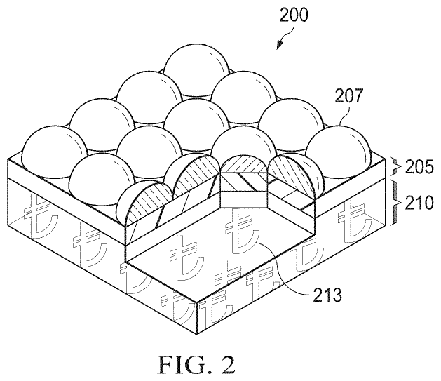

FIG. 2 illustrates an example of a security device 200 which can be affixed to a security document using adhesives according to various embodiments of this disclosure.

Referring to the non-limiting example of FIG. 2, security device 200 comprises a multi-layer micro-optic (MO) security device, of which a section (for example, a section of security thread 110 in FIG. 1) is shown in FIG. 2. According to certain embodiments according to this disclosure, security device 200 comprises an authentication structure with at least two layers, including a focusing layer 205 and a second layer 210.

According to certain embodiments, focusing layer 205 comprises an array of precision formed focusing elements, such as micro-lenses (including, for example, micro-lens 207) formed of a substantially transparent material having a suitable index of refraction. In some embodiments according to this disclosure, focusing layer is disposed on second layer 210, which comprises a layer of substantially optically clear material containing image elements (for example, image element 213) are disposed. In various embodiments, image element 213 is disposed on a top surface of second layer 210. In certain embodiments, image element 213 is disposed within (for example, in a void created in the material of the layer) second layer 210. In some embodiments, image element 213 is disposed on a bottom surface of second layer 210. The positioning of the image elements relative to the focusing elements creates an optical effect, such as a synthetic image, when the image elements are viewed through the focusing elements.

Referring to the non-limiting example of FIG. 2, in certain embodiments, security device 200 has a thickness of approximately 50 microns or less and is affixed via an adhesive applied to the underside of second layer 210 to a paper substrate. Further, to enhance security, in certain embodiments, security device 200 is precisely positioned (for example, relative to a window or printed content in the substrate) on the substrate. Accordingly, the thinness and principles of operation (for example, certain security devices according to this need to be substantially flat and oriented with the focusing elements facing the viewer) of security device 200, can impose further performance requirements on the adhesive used to attach security device 200 to a paper substrate. For example, the adhesive must be thin enough to prevent the security device from curling or wrinkling during the manufacturing process. At the same time, the adhesive must, in certain embodiments, exhibit tackification, such as wet tack (as used herein, the term “wet tack” encompasses the ability to transition from a dry state to a comparatively sticky, or “tacky” state when moistened) between the security device and a moist or semi-moist substrate, so that security device 200 remains in the same location on the substrate during the remainder of the process of manufacturing the security document.

Certain embodiments according to this disclosure comprise an adhesive, which unexpectedly satisfies these additional performance requirements imposed by the thinness and operational principles of security devices (for example, security device 200) suitable for use in security documents.

Although FIG. 2 illustrates one example of a security device, various changes may be made to FIG. 2. For example, security devices suitable for security documents according to this disclosure include, without limitation, refractive security devices (for example, as shown in FIG. 2), security devices with authentication structures using reflective focusing elements, and diffractive security devices, such as holograms). Further examples of security devices which can be incorporated into security documents according to embodiments of this disclosure include security devices using authentication structures which comprise reflective, diffractive, and hybrid optic structures, as well as other single or multi-layer structures, such as conductive traces, circuit patterns, micro-lenses, waveguides, negative space air lenses, insulating ceramic structures, icon image elements, microtext, anti-reflective structures, light refracting prisms, micro-mirror structures, patterned or unpatterned metallization, fluorescent security print, ruled gratings, periodic or aperiodic arrays, structures for increasing a surface area, and tactility altering structures.

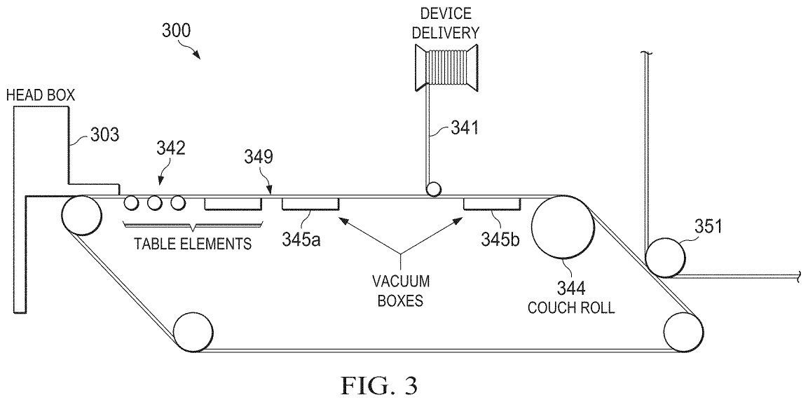

FIG. 3 illustrates an example of a paper machine 300 for implementing methods for creating security documents according to various embodiments of this disclosure.

Referring to the non-limiting example of FIG. 3, paper machine 300 creates a web of a paper substrate which includes security devices (for example, security device 200 in FIG. 200) attached by adhesives according to certain embodiments of this disclosure. According to various embodiments, paper machine 300 forms a continuous web 349 of a fibrous substrate by applying an aqueous slurry across a table with a wire section.

According to various embodiments, paper machine 300 comprises head box 303, which contains an aqueous slurry containing water, cellulose (for example, bleached wood pulp) and, in certain embodiments, binders and/or additional fibrous materials (for example, linen fibers or microthreads) to enhance the strength and security properties of the finished security document. In some embodiments, the aqueous slurry passes from head box 303 onto a wet line 342, which comprises a moving wire mesh through which water drains from the aqueous slurry to form a wet substrate. In various embodiments, a security device 341 (which, in certain embodiments, comprises features and structures of security device 200 in FIG. 2), to which an adhesive according to various embodiments of this disclosure has been applied, is placed on a moving wet substrate which contains sufficient water to activate one or more polymers in the adhesive which exhibit tackification when moistened. As used in this disclosure, the term “tackification” encompasses the property whereby a material can be activated to transition from an initially dry state to a comparatively adhesive state wherein the material exhibits a sticky, or “tacky” feel. According to various embodiments, materials exhibiting tackification can be activated to transition to the comparatively adhesive state through at least one of the following activation modes—moistening, or aqueous activation (creating a condition referred to herein as “wet tack”), exposure to heat (referred to herein as “thermal tackification”), or exposure to a solvent (referred to herein as “solvent tackification”).

According to certain embodiments, polymers which exhibit tackification in response to aqueous activation (for example, contacting a web of material at the wet end of paper machine 300 in FIG. 3), include, without limitation, polyvinylpyrrolidone, carboxymethyl, cellulose, guar, Arabic gum and polyacrylic acid. In various embodiments according to this disclosure, polymers which exhibit tackification in response to thermal activation include, without limitation, polyethylene, ethylene copolymers, polystyrene, poly(vinyl chloride), polytetrafluoroethylene, styrene butadiene rubber (SBR), polyurethane, and ethyl vinyl acetate. According to certain embodiments, polymers which exhibit thermal tackification become tacky at temperatures ranging from 50 degrees Celsius to 200 degrees Celsius, with polymers that exhibit thermal tackification at 80 degrees Celsius being well suited for continuous web processes. Examples of polymers which exhibit solvent tackification include, without limitation, SBR and polypropylene.

In some embodiments, security device 341 comprises a continuous web (for example, a strip) of material having one or more security features (for example, the micro-optics described with respect to security device 200 in FIG. 2) which is continuously applied to continuous web 349 of the fibrous substrate, at a point after the wet line 342 and before couch roll 344. In certain embodiments, security device 341 may be applied between vacuum boxes 345a and 345b, which can assist with setting the security device in the fibrous web. In various embodiments, the moisture provided by the continuous web 349 of the fibrous substrate activates at least one component of the adhesive, such as, for example, a polymer exhibiting tackification to create wet tack between the security device 341 and continuous web 349.

While not shown in FIG. 3, in certain embodiments, paper machine 300 comprises one or more processing sections (for example, a drying section comprising heated drying rollers) which is maintained at or above a temperature in a predetermined range of temperatures. In various embodiments, the range of predetermined temperatures is between 65 and 100 degrees Celsius. In some embodiments, the predetermined range of temperatures covers temperatures greater than 100 degrees Celsius. According to certain embodiments, exposure of the adhesive to a region of paper machine 300 which is at, or above, the temperature in the predetermined range of temperatures, activates a chemical reaction between the cross-linker and one or more of the constituent polymers of the adhesive. According to various embodiments, the predetermined range of temperatures corresponds to a range of temperatures associated with sufficient heat energy for substantially all of the cross-linker to be activated to react with one or more of the constituent polymers of the adhesive at a rate compatible with the time scale associated with manufacturing a security document. As a non-limiting example, consider a chemical reaction between a particular cross-linker and one or more of the constituent polymers of an adhesive can be activated at thirty five (35) degrees Celsius to react proceeds at a rate such that substantially all of the cross-linker reacts with the polymers within an hour. In this purely illustrative example, the chemical reaction can be activated at 50 degrees Celsius to proceed at a rate such that substantially all of the cross-linker reacts with the polymers within fifteen (15) seconds. For most applications, in particular, continuous web paper processing applications, 35 degrees Celsius would be a temperature outside of the predetermined range of temperatures, as the web does not spend an hour on drying rolls, while 50 degrees Celsius would be a temperature within the predetermined range. Skilled artisans will appreciate that, according to certain embodiments, the predetermined range of temperatures, depends on a variety of contextually-specific factors, including, without limitation, the activation energy of the chemical reaction(s) between the cross-linker and the one or more polymers, the amount of time the adhesive is exposed to the source of activation energy (for example, a heated drying roller), and the material properties of surfaces being bonded (for example, the melting point of the polymer substrate of a holographic security thread). In certain embodiments, the chemical reaction between the cross-linker and one or more polymers in the adhesive occurs at one or more reaction sites of the polymer molecules of the adhesive, thereby making one or more of the constituent polymers of the adhesive less reactive. In this way, adhesives according to various embodiments of this disclosure can form an adhesive bond between a paper substrate and a security device which is, without limitation, thin, tenacious and resistant to organic solvents, aqueous solvents and oxidizing agents, when dried and part of a finished security document.

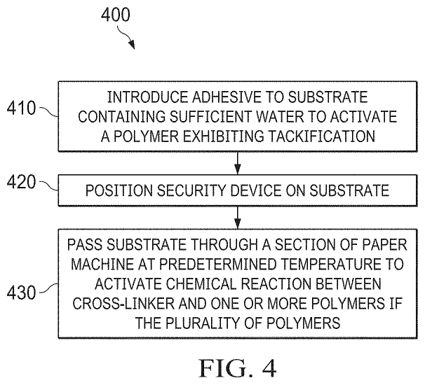

FIG. 4 illustrates operations of a method 400 for making for manufacturing security documents according to various embodiments of this disclosure.

Referring to the non-limiting example of FIG. 4, the operations associated with incorporating a security device (for example, security device 200 in FIG. 2) into a security document are advantageously integrated into a process for making the paper substrate, rather than separately laminating the security device onto a pre-prepared substrate. From a manufacturing standpoint, embodiments according to the method shown in FIG. 4 are advantageous in that they avoid additional manufacturing steps and can utilize existing paper machines. From the performance perspective, embodiments according to the method described with respect to FIG. 4 are likewise advantageous in that they produce a security document in which the security device(s) are affixed to the paper substrate a thin (in certain cases, the dried adhesive layer is ˜3 microns thick), yet tenacious, bond. By contrast, other adhesives, such as certain pressure adhesives, typically produce a weaker interface between a paper substrate and security device with a thickness on the order of ˜25 microns.

As shown in the non-limiting example of FIG. 4, method 400 comprises operation 410, wherein an adhesive is introduced to a substrate (for example, continuous web 349 in FIG. 3) which contains sufficient water to aqueously activate a polymer of the adhesive which exhibits tackification to provide wet tack. In this illustrative example, the adhesive comprises a plurality of polymers that collectively exhibit tackification, resistance to aqueous agents, and solvent resistance, and a cross linker selected to be activated to chemically react with one or more polymers of the plurality of polymers at the temperature in the predetermined range of temperatures. In some embodiments, the adhesive is pre-applied as a wet layer on a surface (for example, the bottom surface of second layer 210 in FIG. 2) of a security device, such as by spraying, or with a Mayer rod. In various embodiments, the adhesive is pre-applied and left to dry as a layer of adhesive on the surface of the security device. Accordingly, when the security device is brought into contact with the wet substrate, the adhesive receives enough moisture to aqueously activate a polymer of the adhesive which exhibits tackification, to provide wet tack between the security device and the substrate.

In certain embodiments according to this disclosure, at operation 420, a security device (for example, security device 200 in FIG. 2) is positioned on a portion of the substrate to which the adhesive has been introduced. According to certain embodiments, the moisture of the wet substrate aqueously activates a polymer of the adhesive which exhibits tackification, causing the adhesive to exhibit wet tack. In some embodiments, the aforementioned polymer is activated in the sense that it absorbs sufficient water to allow physical bonding to a substrate, thereby adhering the security device in substantially the same position relative to the substrate as the substrate continues to pass through the paper machine to become a finished product.

According to certain embodiments, at operation 430, the portion of substrate to which the adhesive has been introduced, and on, or in which the security device has been applied passes through a section of the paper machine (for example, a heated dryer section), which is at or above the temperature in the predetermined range of temperatures, to activate a chemical reaction between the cross-linker and one or more polymers of the plurality of polymers. In certain embodiments, a heated dryer section comprises the section of the paper machine at or above the temperature in the predetermined range of temperatures. Once activated to react, the cross-linker reacts with some or all of the available reaction sites in the molecules of the constituent polymers of the adhesive to effectively “tie up” the reaction sites, thereby diminishing the ability of the constituent polymers of the adhesive to subsequently react with externally applied degradants, such as boiling water, acid solutions, base solutions, oxidizers, or organic solvents (for example, acetone or toluene).

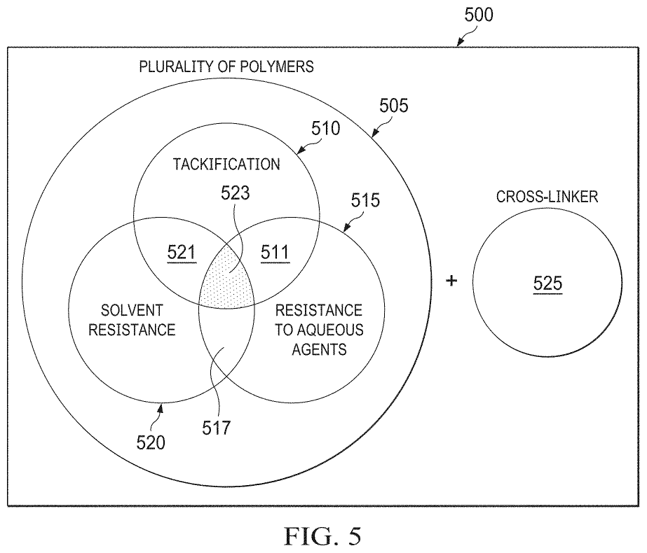

FIG. 5 illustrates aspects of the composition and properties of component compounds of an adhesive (500) according to various embodiments of this disclosure.

Referring to the non-limiting example of FIG. 5, adhesive 500 comprises a plurality of polymers and a cross-linker 525. According to various embodiments, plurality of polymers 505 comprises two or more polymers, which, collectively (as shown by region 523), exhibit the properties of tackification (510), resistance to aqueous agents (515) and solvent resistance (520).

As discussed elsewhere in this disclosure, in certain embodiments, a single polymer can exhibit more than one of tackification 510, resistance to aqueous agents 515 and solvent resistance 520. For example, the material properties of a polymer exhibiting tackification and resistance to aqueous agents are represented by region 511. Similarly, the material properties of a polymer exhibiting resistance to aqueous agents and solvent resistance are represented by region 517 in FIG. 5, and the material properties of a polymer exhibiting solvent resistance and tackification are represented by region 521.

The non-limiting representation of plurality of polymers 505 in FIG. 5 is intended to be explanatory, and the representation of the properties of the polymers of plurality polymers 505 should not be construed as requiring that plurality of polymers 505 comprise a specific number of polymers within the range of two or more polymers.

In certain embodiments according to this disclosure, adhesive 500 further comprises a cross-linker 525, which is selected to be activated to chemically react with one or more polymers of the plurality of polymers 505, at a temperature in a predetermined range of temperatures.

As discussed elsewhere in this disclosure, adhesives according to certain embodiments of this disclosure comprise, without limitation, a plurality of polymers, which collectively, exhibit tackification, water resistance, and solvent resistance. According to various embodiments, the selected plurality of polymers reflects an optimization or balancing of the exhibited desirable properties of among a set of potentially suitable polymers (for example, tackification, water resistance, and solvent-resistance). Further, certain adhesives according to this disclosure comprise one or more polymers which exhibit at least two desirable properties, such as tackification and solvent resistance.

In some embodiments according to this disclosure, the plurality of polymers includes a polymer which exhibits tackification, and can be aqueously activated to provide wet tack using water present in a substrate. The wet tack provided by the tackifying polymer facilitates accurate positioning of the security device on a substrate, and, at the same time, helps resist wrinkling, deregistration or twisting of the security device as the substrate passes through the paper machine.

Examples of polymers which exhibit tackification, and can be used to make adhesives according to some embodiments of this disclosure include, at a minimum, polyvinylpyrrolidone (PVP), polyvinyl alcohol, and caroboxymethyl cellulose (CMC). Examples of polymers which exhibit tackification, and can be included to produce adhesives according to various embodiments of this disclosure also include, without limitation, guar gum, styrene butadiene rubber (SBR), Arabic gum, and polyacrylic acid.

In adhesives according to various embodiments of this disclosure, the plurality of polymers includes at least one polymer which exhibits solvent resistance. Examples of polymers which exhibit solvent resistance, and which are suitable for use in adhesives according to some embodiments of this disclosure include, without limitation, polypropylene (PP), carboxymethyl cellulose (CMC), polyvinyl alcohol, polyetheretherketone (PEEK), and polytetrafluoroethylene (PTFE). Further examples of polymers that exhibit solvent resistance and that are suitable for use in adhesives according to certain embodiments of this disclosure include, without limitation, polyethylene (PE) and ethylene copolymers.

Adhesives according to various embodiments of this disclosure include at least one polymer which exhibits resistance to aqueous agents (for example, acids, bases, and oxidizers) as well as solvents, including organic solvents, such as chlorinated solvents, hydrocarbon solvents and polar and non-polar solvents. In some embodiments, such polymers complement the performance components provided by a polymer which exhibits solvent resistance. Examples of polymers which exhibit resistance to aqueous agents and can be used in adhesives according to some embodiments of this disclosure include, without limitation, polypropylene (PP), polyurethane (PU), polystyrene and styrene copolymers, polyethylene terephthalate (PET) and polyvinyl chloride (PVC). Further examples of polymers which exhibit resistance to aqueous agents and are suitable for use in adhesives according to certain embodiments of this disclosure include, without limitation, polytetrafluoroethylene (PTFE), polyethylene (PE) and ethylene copolymers, polyvinylidene fluoride (PVDF), as well as copolymers of poly(vinyl acetate).

Developing adhesives which comprise polymers which exhibit resistance to aqueous agents, and that are compatible with use in conjunction with paper machines (for example, paper machine 300 in FIG. 3) presents certain technical challenges, which derive from the fact that polymers which exhibit resistance to aqueous agents typically do not “want” to mix with aqueous solutions, or with water provided by a wet substrate. In certain embodiments, to overcome the above-described water resistance and make polymers which exhibit resistance to aqueous agents sufficiently compatible with the water of a wet substrate and aqueous solutions, polymers which exhibit resistance to aqueous agents are provided as a solution, emulsion or dispersion in a liquid matrix.

As noted elsewhere herein, certain polymers suitable for use in adhesives according to embodiments of this disclosure can exhibit more than one of the desirable properties of tackification, resistance to aqueous agents, and resistance to solvents, including organic solvents. For example, certain polymers, including, without limitation, carboxymethyl cellulose (CMC) and polyvinyl alcohol exhibit both tackification and resistance to organic solvents, and can be combined with a second polymer, which exhibits resistance to aqueous agents, and a cross-linker to create an adhesive according to embodiments of this disclosure. As another example, certain other polymers, including, for example, polytetrafluoroethylene (PTFE), polypropylene (PP) and polyethylene (PE) and ethylene copolymers, exhibit both resistance to organic solvents and aqueous agents, and can be combined with a second polymer which exhibits tackification, and a cross-linker, to create one or more adhesives according to embodiments of this disclosure.

Adhesives according to certain embodiments of this disclosure further comprise a cross-linker, which is activated to chemically react with one or more polymers of a plurality of polymers at the temperature in the predetermined range of temperatures. Accordingly, cross-linkers suitable for use in adhesives according to certain embodiments of this disclosure may be selected or formulated to be activated and react at temperatures and on time scales consistent with the manufacture of security documents. Accordingly, cross-linkers which are configured to activate at temperatures much higher than the temperatures realized in a paper machine may be unsuitable. Similarly, cross-linkers which react slowly at lower temperatures are unsuitable, given the speed at which modern paper machines operate. For example, certain paper machines suitable for producing security documents may produce several hundred feet of security documents per minute.

Thus, cross-linkers suitable for use in adhesives according to embodiments of this disclosure are generally selected to be activated to chemically react with one or more of the constituent polymers of the adhesive at the temperatures and time scales associated with a certain point in the manufacture of a security document in a paper machine (for example, paper machine 300 shown in FIG. 3). As such, the activation temperature and reaction speeds associated with cross-linkers suitable for use in adhesives according to this disclosure can present additional technical challenges, including, without limitation, keeping the cross-linker from reacting with other components of the adhesive until matter to be adhered to a paper substrate is correctly positioned relative to the substrate. In certain embodiments according to this disclosure, premature, or unwanted reaction between the cross-linker and other components of the adhesive can be avoided by blocking activation of the chemical reaction between the cross-linker and one or more constituent polymers of the adhesive until an appropriate temperature in the predetermined range of temperatures for activating a chemical reaction is reached.

Examples of cross-linkers suitable for use in adhesives according to various embodiments of this disclosure include, without limitation, glyoxal, glyoxylic acid and salts thereof. Further examples of cross-linkers suitable for use in adhesives according to certain embodiments of this disclosure include, without limitation, glutaraldehyde, isocyanates, aziridines, and carbodiimides.

According to certain embodiments, the cross-linker is selected to be activated to chemically react with at least one of a plurality of polymers in the adhesive. In certain embodiments, the cross-linker reacts with the one or more polymers which exhibit resistance to aqueous agents (for example, polyurethane) and tackification (for example, carboxymethyl cellulose). In certain embodiments, the cross-linker reacts with the one or more polymers which exhibit solvent resistance (for example, co-polymers of ethylene). In various embodiments, the cross-linker reacts with at least one polymer which exhibits tackification, at least one polymer which exhibits solvent resistance and at least one polymer which exhibits resistance to aqueous agents.

Examples of adhesives according to some embodiments of this disclosure include adhesives which comprise a plurality of polymers, that collectively, exhibit tackification, resistance to aqueous agents, and solvent resistance, and a cross-linker selected to be activated to chemically react with one or more polymers of the plurality of polymers, at a temperature in a predetermined range of temperatures.

Examples of adhesives according to various embodiments of this disclosure include adhesives, wherein a first polymer of the plurality of polymers exhibits tackification and solvent resistance.

Examples of adhesives according to some embodiments of this disclosure include adhesives, wherein the first polymer does not exhibit resistance to aqueous agents.

Examples of adhesives according to certain embodiments of this disclosure include adhesives, wherein a first polymer of the plurality of polymers exhibits resistance to aqueous agents and solvent resistance.

Examples of adhesives according to various embodiments of this disclosure include adhesives, wherein the first polymer does not exhibit tackification.

Examples of adhesives according to certain embodiments of this disclosure include adhesives, which further comprise a third polymer and, wherein a first polymer of the plurality of polymers exhibits resistance to aqueous agents, a second polymer of the plurality of polymers exhibits solvent resistance, the third polymer of the plurality of polymers exhibits tackification, and the cross-linker is selected to be activated to chemically react with one or more of the first polymer, second polymer, or third polymer, at the temperature in the predetermined range of temperatures.

Examples of adhesives according to some embodiments of this disclosure include adhesives, wherein the adhesive exhibits wet tack from contact with a substrate containing sufficient water to activate a polymer of the plurality of polymers that exhibits tackification.

Examples of adhesives according to various embodiments of this disclosure include adhesives wherein a polymer of the plurality of polymers that exhibits tackification comprises at least one of polyvinylpyrrolidone, carboxymethyl cellulose, guar, styrene butadiene rubber, Arabic gum or polyacrylic acid.

Examples of adhesives according to some embodiments of this disclosure include adhesives, wherein a polymer of the plurality of polymers that exhibits resistance to aqueous agents is provided as a solution, emulsion or dispersion in a liquid matrix.

Examples of adhesives according to certain embodiments of this disclosure include adhesives, wherein a polymer of the plurality of polymers that exhibits solvent resistance comprises at least one of polyethylene, an ethylene copolymer, polypropylene, polytetrafluoroethylene, carboxymethyl cellulose or polyetheretherketone.

Examples of adhesives according to various embodiments of this disclosure include adhesives, wherein a polymer of the plurality of polymers that exhibits resistance to aqueous agents comprises at least one of polyvinylidene fluoride, polyethylene terephthalate, polyvinyl chloride, polyethylene, ethylene copolymers, polypropylene, polytetrafluoroethylene, polyurethane, as well as copolymers of poly(vinyl acetate).

Examples of adhesives according to some embodiments of this disclosure include adhesives, wherein the temperature in the predetermined range of temperatures is greater than 100 degrees Celsius.

Examples of adhesives according to certain embodiments of this disclosure include adhesives, wherein the temperature in the predetermined range of temperatures is between 65 and 100 degrees Celsius.

Examples of adhesives according to certain embodiments of this disclosure include adhesives, which further comprise a blocking agent which deactivates at the temperature in the predetermined range of temperatures.

Examples of adhesives according to certain embodiments of this disclosure include adhesives, wherein the cross-linker comprises one or more of an aziridine, a carbodiimide, an isocyanate, a glutaraldehyde, glyoxal, glyoxylic acid or a salt thereof.

Examples of adhesives according to some embodiments of this disclosure include adhesives, wherein the cross-linker is selected to be activated to chemically react with a polymer of the plurality of polymers that exhibits tackification, at the temperature in the predetermined range of temperatures.

Examples of adhesives according to various embodiments of this disclosure include adhesives, wherein the cross-linker is selected to be activated to chemically react with a polymer of the plurality of polymers that exhibits solvent resistance, at the temperature in the predetermined range of temperatures.

Examples of adhesives according to certain embodiments of this disclosure include adhesives, wherein the cross-linker is selected to be activated to chemically react with a polymer of the plurality of polymers that exhibits resistance to aqueous agents, at the temperature in the predetermined range of temperatures.

Examples of adhesives according to some embodiments of this disclosure include adhesives, wherein the cross-linker is selected to be activated to chemically react with one or more polymers of the plurality of polymers that collectively exhibit tackification and resistance to aqueous agents, at the temperature in the predetermined range of temperatures.

Examples of adhesives according to various embodiments of this disclosure include adhesives, wherein the cross-linker is selected to be activated to not chemically react with one or more polymers of the plurality of polymers that exhibit solvent resistance, at the temperature in the predetermined range of temperatures.

Examples of adhesives according to certain embodiments of this disclosure include adhesives, wherein the cross-linker is selected to chemically react with each polymer of the plurality of polymers that collectively exhibit tackification, resistance to aqueous agents and solvent resistance, at or above the temperature in the predetermined range of temperatures.

Examples of adhesives according to some embodiments of this disclosure include adhesives, wherein the plurality of polymers does not include a single polymer which exhibits all three of tackification, solvent resistance and resistance to aqueous agents.

Examples of security documents according to various embodiments of this disclosure include security documents which comprise a paper substrate, a security device, and an adhesive layer comprising an adhesive, the adhesive layer providing a bond between the security device and the paper substrate, wherein the adhesive comprises a plurality of polymers, that collectively exhibit tackification, resistance to aqueous agents, and solvent resistance, and a cross-linker selected to be activated to chemically react with one or more polymers of the plurality of polymers, at a temperature in a predetermined range of temperatures.

Examples of security documents according to certain embodiments of this disclosure include security documents, wherein a first polymer of the plurality of polymers exhibits tackification and solvent resistance.

Examples of security documents according to some embodiments of this disclosure include security documents, wherein the first polymer does not exhibit resistance to aqueous agents.

Examples of security documents according to various embodiments of this disclosure include security documents, wherein a first polymer of the plurality of polymers exhibits resistance to aqueous agents and solvent resistance.

Examples of security documents according to certain embodiments of this disclosure include security documents, wherein the first polymer does not exhibit tackification.

Examples of security documents according to some embodiments of this disclosure include security documents, which comprise a third polymer, and wherein a first polymer of the plurality of polymers exhibits resistance to aqueous agents, a second polymer of the plurality of polymers exhibits solvent resistance, the third polymer of the plurality of polymers exhibits tackification, and the cross-linker is selected to be activated to chemically react with one or more of the first polymer, second polymer, and third polymer, at the temperature in the predetermined range of temperatures.

Examples of security documents according to various embodiments of this disclosure include security documents, wherein the adhesive layer has a thickness of 10 microns or less.

Examples of security documents according to certain embodiments of this disclosure include security documents, wherein the adhesive layer has a thickness of 5 microns or less.

Examples of security documents according to some embodiments of this disclosure include security documents, wherein the adhesive exhibits wet tack from contact with a substrate containing sufficient water to activate a polymer of the plurality of polymers that exhibits tackification.

Examples of security documents according to various embodiments of this disclosure include security documents, wherein a polymer of the plurality of polymers that exhibits tackification comprises at least one of polyvinylpyrrolidone, carboxymethyl cellulose, guar, styrene butadiene rubber, Arabic gum or polyacrylic acid.

Examples of security documents according to certain embodiments of this disclosure include security documents, wherein a polymer of the plurality of polymers that exhibits resistance to aqueous agents is provided as a solution, emulsion or dispersion in a liquid matrix.

Examples of security documents according to some embodiments of this disclosure include security documents, wherein a polymer of the plurality of polymers that exhibits solvent resistance comprises at least one of polyethylene, an ethylene copolymer, polypropylene, polytetrafluoroethylene, carboxymethyl cellulose or polyetheretherketone.

Examples of security documents according to various embodiments of this disclosure include security documents, wherein a polymer of the plurality of polymers that exhibits resistance to aqueous agents comprises at least one of polyvinylidene fluoride, polyethylene terephthalate, polyvinyl chloride, polyethylene, ethylene copolymers, polypropylene, polytetrafluoroethylene, polyurethane, as well as copolymers of poly(vinyl acetate).

Examples of security documents according to certain embodiments of this disclosure include security documents, wherein the temperature in the predetermined range of temperatures is greater than 100 degrees Celsius.

Examples of security documents according to some embodiments of this disclosure include security documents, wherein the temperature in the predetermined range of temperatures is between 65 and 100 degrees Celsius.

Examples of security documents according to various embodiments of this disclosure include security documents, wherein the adhesive further comprises a blocking agent which deactivates at the temperature in the predetermined range of temperatures.

Examples of security documents according to certain embodiments of this disclosure include security documents, wherein the cross-linker comprises one or more of an aziridine, a carbodiimide, an isocyanate, a glutaraldehyde, glyoxal, glyoxylic acid or a salt thereof.

Examples of security documents according to some embodiments of this disclosure include security documents, wherein the cross-linker is selected to be activated to chemically react with a polymer of the plurality of polymers that exhibits tackification, at the temperature in the predetermined range of temperatures.

Examples of security documents according to various embodiments of this disclosure include security documents, wherein the cross-linker is selected to be activated to chemically react with a polymer of the plurality of polymers that exhibits solvent resistance, at the temperature in the predetermined range of temperatures.

Examples of security documents according to certain embodiments of this disclosure include security documents, wherein the cross-linker is selected to be activated to chemically react with a polymer of the plurality of polymers that exhibits resistance to aqueous agents, at the temperature in the predetermined range of temperatures.

Examples of security documents according to some embodiments of this disclosure include security documents, wherein the cross-linker is selected to be activated to chemically react with one or more polymers of the plurality of polymers that collectively exhibit tackification and resistance to aqueous agents, at the temperature in the predetermined range of temperatures.

Examples of security documents according to various embodiments of this disclosure include security documents, wherein the cross-linker is selected to chemically react with each polymer of the plurality of polymers that collectively exhibit tackification, resistance to aqueous agents and solvent resistance, at or above the temperature in the predetermined range of temperatures.

Examples of security documents according to certain embodiments of this disclosure include security documents, wherein the plurality of polymers does not include a single polymer which exhibits all three of tackification, solvent resistance and resistance to aqueous agents.

Examples of a method of making a security document according to some embodiments of this disclosure include a method of making a security document which includes, at a paper machine configured to pass a substrate containing water through one or more processing sections, introducing an adhesive to create an adhesive layer, the adhesive comprising a plurality of polymers that collectively exhibit tackification, resistance to aqueous agents, and solvent resistance, and a cross-linker selected to be activated to chemically react with one or more polymers of the plurality of polymers, at a temperature in a predetermined range of temperatures, positioning a security device on a first portion of the substrate to which the adhesive has been introduced, and passing the first portion of the substrate to a processing section of the paper machine at the temperature in the predetermined range of temperatures to activate the cross-linker to chemically react with one or more polymers of the plurality of polymers, wherein the adhesive is introduced to the substrate at a processing section of the paper machine where the substrate contains sufficient water to activate a polymer of the plurality of polymers that exhibits tackification, to provide wet tack.

Examples of methods of making a security document according to certain embodiments of this disclosure include methods, wherein a first polymer of the plurality of polymers exhibits tackification and solvent resistance.

Examples of methods of making a security document according to some embodiments of this disclosure include methods wherein the first polymer does not exhibit resistance to aqueous agents.

Examples of methods of making a security document according to various embodiments of this disclosure include methods wherein a first polymer of the plurality of polymers exhibits resistance to aqueous agents and solvent resistance.

Examples of methods of making a security document according to certain embodiments of this disclosure include methods wherein the first polymer does not exhibit tackification.

Examples of methods of making a security document according to some embodiments of this disclosure include methods wherein the adhesive further comprises a third polymer, wherein a first polymer of the plurality of polymers exhibits resistance to aqueous agents, a second polymer of the plurality of polymers exhibits solvent resistance, the third polymer of the plurality of polymers exhibits tackification, and wherein the cross-linker is selected to be activated to chemically react with one or more of the first polymer, second polymer and third polymer, at the temperature in the predetermined range of temperatures.

Examples of methods of making a security document according to various embodiments of this disclosure include methods wherein a polymer of the plurality of polymers that exhibits tackification comprises at least one of polyvinylpyrrolidone, carboxymethyl cellulose, guar, styrene butadiene rubber, Arabic gum or polyacrylic acid.

Examples of methods of making a security document according to certain embodiments of this disclosure include methods wherein a polymer of the plurality of polymers that exhibits resistance to aqueous agents is provided as a solution, emulsion or dispersion in a liquid matrix.

Examples of methods of making a security document according to some embodiments of this disclosure include methods, wherein a polymer of the plurality of polymers that exhibits solvent resistance comprises at least one of polyethylene, an ethylene copolymer, polypropylene, polytetrafluoroethylene, carboxymethyl cellulose or polyetheretherketone.

Examples of methods of making a security document according to various embodiments of this disclosure include methods wherein a polymer of the plurality of polymers that exhibits resistance to aqueous agents comprises at least one of polyvinylidene fluoride, polyethylene terephthalate, polyvinyl chloride, polyethylene, ethylene copolymers, polypropylene, polytetrafluoroethylene, polyurethane, polyvinyl acetate and copolymers thereof

Examples of methods of making a security document according to certain embodiments of this disclosure include methods, wherein the temperature in the predetermined range of temperatures is greater than 100 degrees Celsius.

Examples of methods of making a security document according to some embodiments of this disclosure include methods wherein the temperature in the predetermined range of temperatures is between 65 and 100 degrees Celsius.

Examples of methods of making a security document according to various embodiments of this disclosure include methods wherein the adhesive is introduced to form a dried adhesive layer having a thickness of 10 microns or less.

Examples of methods of making a security document according to certain embodiments of this disclosure include methods, wherein the adhesive is introduced to form a dried adhesive layer having a thickness of 5 microns or less.

Examples of methods of making a security document according to some embodiments of this disclosure include methods, wherein the adhesive further comprises a blocking agent which deactivates at the temperature in the predetermined range of temperatures.

Examples of methods of making a security document according to various embodiments of this disclosure include methods wherein the cross-linker comprises one or more of an aziridine, a carbodiimide, an isocyanate, a glutaraldehyde, glyoxal, glyoxylic acid or a salt thereof.

Examples of methods of making a security document according to certain embodiments of this disclosure include methods wherein the cross-linker is selected to be activated to chemically react with a polymer of the plurality of polymers that exhibits tackification, at the temperature in the predetermined range of temperatures.

Examples of methods of making a security document according to some embodiments of this disclosure include methods wherein the cross-linker is selected to be activated to chemically react with a polymer of the plurality of polymers that exhibits solvent resistance, at the temperature in the predetermined range of temperatures.

Examples of methods of making a security document according to various embodiments of this disclosure include methods wherein the cross-linker is selected to be activated to chemically react with a polymer of the plurality of polymers that exhibits resistance to aqueous agents, at the temperature in the predetermined range of temperatures.

Examples of methods of making a security document according to certain embodiments of this disclosure include methods wherein the cross-linker is selected to be activated to chemically react with one or more polymers of the plurality of polymers that collectively exhibit tackification and resistance to aqueous agents, at the temperature in the predetermined range of temperatures.

Examples of methods of making a security document according to some embodiments of this disclosure include methods wherein the cross-linker is selected to chemically react with each polymer of the plurality of polymers that collectively exhibit tackification, resistance to aqueous agents and solvent resistance, at or above the temperature in a predetermined range of temperatures.

Examples of methods of making a security document according to various embodiments of this disclosure include methods wherein the plurality of polymers does not include a single polymer which exhibits all three of tackification, solvent resistance and resistance to aqueous agents.

Examples of security devices according to certain embodiments of this disclosure include security devices comprising an authentication structure, and an adhesive layer comprising an adhesive, the adhesive layer providing a bond between the security device and a substrate, wherein the adhesive comprises a plurality of polymers, that collectively exhibit tackification, resistance to aqueous agents, and solvent resistance and a cross-linker selected to be activated to chemically react with one or more polymers of the plurality of polymers, at a temperature in a predetermined range of temperatures.

Examples of security devices according to some embodiments of this disclosure include security devices, wherein a first polymer of the plurality of polymers of the adhesive exhibits tackification and solvent resistance.

Examples of security devices according to various embodiments of this disclosure include security devices, wherein the first polymer of the plurality of polymers of the adhesive does not exhibit resistance to aqueous agents.

Examples of security devices according to certain embodiments of this disclosure include security devices, wherein a first polymer of the plurality of polymers of the adhesive exhibits resistance to aqueous agents and solvent resistance.

Examples of security devices according to some embodiments of this disclosure include security devices, wherein the first polymer of the plurality of polymers of the adhesive does not exhibit tackification.

Examples of security devices according to various embodiments of this disclosure include security devices, further comprising a third polymer of the plurality of polymers of the adhesive, and wherein a first polymer of the plurality of polymers of the adhesive exhibits resistance to aqueous agents, a second polymer of the plurality of polymers of the adhesive exhibits solvent resistance, the third polymer of the plurality of polymers of the adhesive exhibits tackification, and the cross-linker is selected to be activated to chemically react with one or more of the first polymer, second polymer, and third polymer, at the temperature in the predetermined range of temperatures.

Examples of security devices according to certain embodiments of this disclosure include security devices, wherein the adhesive layer has a thickness of 10 microns or less.

Examples of security devices according to some embodiments of this disclosure include security devices, wherein the adhesive layer has a thickness of 5 microns or less.

Examples of security devices according to various embodiments of this disclosure include security devices, wherein the adhesive exhibits wet tack from contact with a fibrous substrate containing sufficient water to activate a polymer of the plurality of polymers of the adhesive that exhibits tackification.

Examples of security devices according to certain embodiments of this disclosure include security devices, wherein a polymer of the plurality of polymers of the adhesive that exhibits tackification comprises at least one of polyvinylpyrrolidone, carboxymethyl cellulose, guar, styrene butadiene rubber, Arabic gum or polyacrylic acid.

Examples of security devices according to some embodiments of this disclosure include security devices, wherein a polymer of the plurality of polymers of the adhesive that exhibits resistance to aqueous agents is provided as a solution, emulsion or dispersion in a liquid matrix.

Examples of security devices according to various embodiments of this disclosure include security devices, wherein a polymer of the plurality of polymers of the adhesive that exhibits solvent resistance comprises at least one of polyethylene, an ethylene copolymer, polypropylene, polytetrafluoroethylene, carboxymethyl cellulose or polyetheretherketone.

Examples of security devices according to certain embodiments of this disclosure include security devices, wherein a polymer of the plurality of polymers of the adhesive that exhibits resistance to aqueous agents comprises at least one of polyvinylidene fluoride, polyethylene terephthalate, polyvinyl chloride, polyethylene, ethylene copolymers, polypropylene, polytetrafluoroethylene, polyurethane, polyvinyl acetate or a copolymer thereof

Examples of security devices according to some embodiments of this disclosure include security devices, wherein the temperature in the predetermined range of temperatures is greater than 100 degrees Celsius.

Examples of security devices according to various embodiments of this disclosure include security devices, wherein the temperature in the predetermined range of temperatures is between 65 and 100 degrees Celsius.

Examples of security devices according to certain embodiments of this disclosure include security devices, wherein the adhesive further comprises a blocking agent which deactivates at the temperature in the predetermined range of temperatures.

Examples of security devices according to some embodiments of this disclosure include security devices, wherein the cross-linker comprises one or more of an aziridine, a carbodiimide, an isocyanate, a glutaraldehyde, glyoxal, glyoxylic acid or a salt thereof.

Examples of security devices according to various embodiments of this disclosure include security devices, wherein the cross-linker is selected to be activated to chemically react with a polymer of the plurality of polymers of the adhesive that exhibits tackification, at the temperature in the predetermined range of temperatures.

Examples of security devices according to certain embodiments of this disclosure include security devices, wherein the cross-linker is selected to be activated to chemically react with a polymer of the plurality of polymers of the adhesive that exhibits solvent resistance, at the temperature in the predetermined range of temperatures.

Examples of security devices according to some embodiments of this disclosure include security devices, wherein the cross-linker is selected to be activated to chemically react with a polymer of the plurality of polymers of the adhesive that exhibits resistance to aqueous agents, at the temperature in the predetermined range of temperatures.

Examples of security devices according to various embodiments of this disclosure include security devices, wherein the cross-linker is selected to be activated to chemically react with one or more polymers of the plurality of polymers of the adhesive that collectively exhibit tackification and resistance to aqueous agents, at the temperature in the predetermined range of temperatures.

Examples of security devices according to certain embodiments of this disclosure include security devices, wherein the cross-linker is selected to chemically react with each polymer of the plurality of polymers of the adhesive that collectively exhibit tackification, resistance to aqueous agents and solvent resistance, at or above the temperature in the predetermined range of temperatures.

Examples of security devices according to some embodiments of this disclosure include security devices, wherein the plurality of polymers of the adhesive does not include a single polymer which exhibits all three of tackification, solvent resistance and resistance to aqueous agents.

Examples of security devices according to various embodiments of this disclosure include security devices, wherein the substrate is a continuous web to be applied as a security thread to a security document.

Examples of security devices according to certain embodiments of this disclosure include security devices, wherein the authentication structure comprises a focusing layer.

Examples of security devices according to some embodiments of this disclosure include security devices, wherein the focusing layer comprises one or more of an array of refractive focusing elements or an array of reflective focusing elements.

Examples of security devices according to various embodiments of this disclosure include security devices, wherein the authentication structure produces a synthetic image.

Examples of security devices according to certain embodiments of this disclosure include security devices, wherein the authentication structure comprises one or more of, a diffractive security device, a conductive trace, a circuit pattern, a wave guide, a negative space air lens, an insulating ceramic structure, an icon image element, microtext, an anti-reflective structure, a light refracting prism, a micro-mirror structure, a patterned metallization, an unpatterned metallization, a fluorescent security print, a ruled grating, a periodic array, an aperiodic array, a structure for increasing surface area or a tactility altering structure.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle.

What is claimed is:

1. An adhesive, comprising:
a plurality of polymers, that collectively exhibit tackification, resistance to aqueous agents, and solvent resistance; and
a cross-linker selected to be activated to chemically react with one or more polymers of the plurality of polymers, at a temperature in a predetermined range of temperatures.

2. The adhesive of claim 1, wherein a first polymer of the plurality of polymers exhibits tackification and solvent resistance.

3. The adhesive of claim 2, wherein the first polymer does not exhibit resistance to aqueous agents.

4. The adhesive of claim 1, wherein a first polymer of the plurality of polymers exhibits resistance to aqueous agents and solvent resistance.

5. The adhesive of claim 4, wherein the first polymer does not exhibit tackification.

6. The adhesive of claim 1, further comprising a third polymer, wherein:
a first polymer of the plurality of polymers exhibits resistance to aqueous agents;
a second polymer of the plurality of polymers exhibits solvent resistance;
the third polymer of the plurality of polymers exhibits tackification; and
the cross-linker is selected to be activated to chemically react with one or more of the first polymer, the second polymer, and the third polymer, at the temperature in the predetermined range of temperatures.

7. The adhesive of claim 1, wherein the adhesive exhibits wet tack from contact with a substrate containing sufficient water to activate a polymer of the plurality of polymers that exhibits tackification.

8. The adhesive of claim 1, wherein a polymer of the plurality of polymers that exhibits tackification comprises at least one of polyvinylpyrrolidone, carboxymethyl cellulose, guar, styrene butadiene rubber, Arabic gum or polyacrylic acid.

9. The adhesive of claim 1, wherein a polymer of the plurality of polymers that exhibits resistance to aqueous agents is provided as a solution, emulsion or dispersion in a liquid matrix.

10. The adhesive of claim 1, wherein a polymer of the plurality of polymers that exhibits solvent resistance comprises at least one of polyethylene, an ethylene copolymer, polypropylene, polytetrafluoroethylene, carboxymethyl cellulose or polyetheretherketone.

11. The adhesive of claim 1, wherein a polymer of the plurality of polymers that exhibits resistance to aqueous agents comprises at least one of polyvinylidene fluoride, polyethylene terephthalate, polyvinyl chloride, polyethylene, ethylene copolymers, polypropylene, polytetrafluoroethylene, polyurethane, or a copolymer of poly(vinyl acetate).

12. The adhesive of claim 1, wherein the temperature in the predetermined range of temperatures is greater than 100 degrees Celsius.

13. The adhesive of claim 1, wherein the temperature in the predetermined range of temperatures is between 65 and 100 degrees Celsius.

14. The adhesive of claim 1, further comprising a blocking agent which deactivates at the temperature in the predetermined range of temperatures.

15. The adhesive of claim 1, wherein the cross-linker comprises one or more of an aziridine, a carbodiimide, an isocyanate, a glutaraldehyde, glyoxal, glyoxylic acid or a salt thereof.

16. The adhesive of claim 1, wherein the cross-linker is selected to be activated to chemically react with a polymer of the plurality of polymers that exhibits tackification, at the temperature in the predetermined range of temperatures.

17. The adhesive of claim 1, wherein the cross-linker is selected to be activated to chemically react with a polymer of the plurality of polymers that exhibits solvent resistance, at the temperature in the predetermined range of temperatures.

18. The adhesive of claim 1, wherein the cross-linker is selected to be activated to chemically react with a polymer of the plurality of polymers that exhibits resistance to aqueous agents, at the temperature in the predetermined range of temperatures.

19. The adhesive of claim 1, wherein the cross-linker is selected to be activated to chemically react with one or more polymers of the plurality of polymers that collectively exhibit tackification and resistance to aqueous agents, at the temperature in the predetermined range of temperatures.

20. The adhesive of claim 1, wherein the cross-linker is selected to be activated to not chemically react with one or more polymers of the plurality of polymers that exhibit solvent resistance, at the temperature in the predetermined range of temperatures.

21. The adhesive of claim 1, wherein the cross-linker is selected to chemically react with each polymer of the plurality of polymers that collectively exhibit tackification, resistance to aqueous agents and solvent resistance, at or above the temperature in a predetermined range of temperatures.

22. The adhesive of claim 1, wherein the plurality of polymers does not include a single polymer which exhibits all three of tackification, solvent resistance and resistance to aqueous agents.

23. A security document, comprising:
a paper substrate;
a security device; and
an adhesive layer comprising an adhesive, the adhesive layer providing a bond between the security device and the paper substrate,
wherein the adhesive comprises a plurality of polymers, that collectively exhibit tackification, resistance to aqueous agents, and solvent resistance, and a cross-linker selected to be activated to chemically react with one or more polymers of the plurality of polymers, at a temperature in a predetermined range of temperatures.

24. The security document of claim 23, wherein a first polymer of the plurality of polymers exhibits tackification and solvent resistance.

25. The security document of claim 24, wherein the first polymer does not exhibit resistance to aqueous agents.

26. The security document of claim 23, wherein a first polymer of the plurality of polymers exhibits resistance to aqueous agents and solvent resistance.

27. The security document of claim 26, wherein the first polymer does not exhibit tackification.

28. The security document of claim 23, further comprising a third polymer, and wherein a first polymer of the plurality of polymers exhibits resistance to aqueous agents, a second polymer of the plurality of polymers exhibits solvent resistance, the third polymer of the plurality of polymers exhibits tackification, and the cross-linker is selected to be activated to chemically react with one or more of the first polymer, the second polymer, and the third polymer, at the temperature in the predetermined range of temperatures.

29. The security document of claim 23, wherein the adhesive layer has a thickness of 10 microns or less.

30. The security document of claim 23, wherein the adhesive layer has a thickness of 5 microns or less.

31. The security document of claim 23, wherein the adhesive exhibits wet tack from contact with a substrate containing sufficient water to activate a polymer of the plurality of polymers that exhibits tackification.

32. The security document of claim 23, wherein a polymer of the plurality of polymers that exhibits tackification comprises at least one of polyvinylpyrrolidone, carboxymethyl cellulose, guar, styrene butadiene rubber, Arabic gum or polyacrylic acid.

33. The security document of claim 23, wherein a polymer of the plurality of polymers that exhibits resistance to aqueous agents is provided as a solution, emulsion or dispersion in a liquid matrix.

34. The security document of claim 23, wherein a polymer of the plurality of polymers that exhibits solvent resistance comprises at least one of polyethylene, an ethylene copolymer, polypropylene, polytetrafluoroethylene, carboxymethyl cellulose or polyetheretherketone.

35. The security document of claim 23, wherein a polymer of the plurality of polymers that exhibits resistance to aqueous agents comprises at least one of polyvinylidene fluoride, polyethylene terephthalate, polyvinyl chloride, polyethylene, ethylene copolymers, polypropylene, polytetrafluoroethylene, polyurethane, or a copolymer of poly(vinyl acetate).

36. The security document of claim 23, wherein the temperature in the predetermined range of temperatures is greater than 100 degrees Celsius.

37. The security document of claim 23, wherein the temperature in the predetermined range of temperatures is between 65 and 100 degrees Celsius.

38. The security document of claim 23, wherein the adhesive further comprises a blocking agent which deactivates at the temperature in the predetermined range of temperatures.

39. The security document of claim 23, wherein the cross-linker comprises one or more of an aziridine, a carbodiimide, an isocyanate, a glutaraldehyde, glyoxal, glyoxylic acid or a salt thereof

40. The security document of claim 23, wherein the cross-linker is selected to be activated to chemically react with a polymer of the plurality of polymers that exhibits tackification, at the temperature in the predetermined range of temperatures.

41. The security document of claim 23, wherein the cross-linker is selected to be activated to chemically react with a polymer of the plurality of polymers that exhibits solvent resistance, at the temperature in the predetermined range of temperatures.

42. The security document of claim 23, wherein the cross-linker is selected to be activated to chemically react with a polymer of the plurality of polymers that exhibits resistance to aqueous agents, at the temperature in the predetermined range of temperatures.

43. The security document of claim 23, wherein the cross-linker is selected to be activated to chemically react with one or more polymers of the plurality of polymers that collectively exhibit tackification, and resistance to aqueous agents, at the temperature in the predetermined range of temperatures.

44. The security document of claim 23, wherein the cross-linker is selected to chemically react with each polymer of the plurality of polymers that collectively exhibit tackification, resistance to aqueous agents and solvent resistance, at or above the temperature in the predetermined range of temperatures.

45. The security document of claim 23, wherein the plurality of polymers does not include a single polymer which exhibits all three of tackification, solvent resistance and resistance to aqueous agents.

46. A method of making a security document, the method comprising:
at a paper machine configured to pass a substrate containing water through one or more processing sections, introducing an adhesive to create an adhesive layer, the adhesive comprising a plurality of polymers that collectively exhibit tackification, resistance to aqueous agents, and solvent resistance, and a cross-linker selected to be activated to chemically react with one or more polymers of the plurality of polymers, at a temperature in a predetermined range of temperatures;
positioning a security device on a first portion of the substrate to which the adhesive has been introduced; and
passing the first portion of the substrate to a processing section of the paper machine at the temperature in the predetermined range of temperatures to activate the cross-linker to chemically react with one or more polymers of the plurality of polymers,
wherein the adhesive is introduced to the substrate at a processing section of the paper machine where the substrate contains sufficient water to activate a polymer of the plurality of polymers that exhibits tackification, to provide wet tack.

47. The method of claim 46, wherein a first polymer of the plurality of polymers exhibits tackification and solvent resistance.

48. The method of claim 47, wherein the first polymer does not exhibit resistance to aqueous agents.

49. The method of claim 46, wherein a first polymer of the plurality of polymers exhibits resistance to aqueous agents and solvent resistance.

50. The method of claim 49, wherein the first polymer does not exhibit tackification.

51. The method of claim 46, wherein the adhesive further comprises a third polymer, wherein a first polymer of the plurality of polymers exhibits resistance to aqueous agents, a second polymer of the plurality of polymers exhibits solvent resistance, the third polymer of the plurality of polymers exhibits tackification, and wherein the cross-linker is selected to be activated to chemically react with one or more of the first polymer, the second polymer, and the third polymer, at the temperature in the predetermined range of temperatures.

52. The method of claim 46, wherein a polymer of the plurality of polymers that exhibits tackification comprises at least one of polyvinylpyrrolidone, carboxymethyl cellulose, guar, styrene butadiene rubber, Arabic gum or polyacrylic acid.

53. The method of claim 46, wherein a polymer of the plurality of polymers that exhibits resistance to aqueous agents is provided as a solution, emulsion or dispersion in a liquid matrix.

54. The method of claim 46, wherein a polymer of the plurality of polymers that exhibits solvent resistance comprises at least one of polyethylene, an ethylene copolymer, polypropylene, polytetrafluoroethylene, carboxymethyl cellulose or polyetheretherketone.

55. The method of claim 46, wherein a polymer of the plurality of polymers that exhibits resistance to aqueous agents comprises at least one of polyvinylidene fluoride, polyethylene terephthalate, polyvinyl chloride, polyethylene, ethylene copolymers, polypropylene, polytetrafluoroethylene, polyurethane, or a copolymer of poly(vinyl acetate).

56. The method of claim 46, wherein the temperature in the predetermined range of temperatures is greater than 100 degrees Celsius.

57. The method of claim 46, wherein the temperature in the predetermined range of temperatures is between 65 and 100 degrees Celsius.

58. The method of claim 46, wherein the adhesive is introduced to form a dried adhesive layer having a thickness of 10 microns or less.

59. The method of claim 46, wherein the adhesive is introduced to form a dried adhesive layer having a thickness of 5 microns or less.

60. The method of claim 46, wherein the adhesive further comprises a blocking agent which deactivates at the temperature in the predetermined range of temperatures.

61. The method of claim 46, wherein the cross-linker comprises one or more of an aziridine, a carbodiimide, an isocyanate, a glutaraldehyde, glyoxal, glyoxylic acid or a salt thereof.

62. The method of claim 46, wherein the cross-linker is selected to be activated to chemically react with a polymer of the plurality of polymers that exhibits tackification, at the temperature in the predetermined range of temperatures.

63. The method of claim 46, wherein the cross-linker is selected to be activated to chemically react with a polymer of the plurality of polymers that exhibits solvent resistance, at the temperature in the predetermined range of temperatures.

64. The method of claim 46, wherein the cross-linker is selected to be activated to chemically react with a polymer of the plurality of polymers that exhibits resistance to aqueous agents, at the temperature in the predetermined range of temperatures.

65. The method of claim 46, wherein the cross-linker is selected to be activated to chemically react with one or more polymers of the plurality of polymers that collectively exhibit tackification and resistance to aqueous agents, at the temperature in the predetermined range of temperatures.

66. The method of claim 46, wherein the cross-linker is selected to chemically react with each polymer of the plurality of polymers that collectively exhibit tackification, resistance to aqueous agents and solvent resistance, at or above the temperature in the predetermined range of temperatures.

67. The method of claim 46, wherein the plurality of polymers does not include a single polymer which exhibits all three of tackification, solvent resistance and resistance to aqueous agents.

68. A security device, comprising:
an authentication structure; and
an adhesive layer comprising an adhesive, the adhesive layer providing a bond between the security device and a substrate,
wherein the adhesive comprises a plurality of polymers, that collectively exhibit tackification, resistance to aqueous agents, solvent resistance, and a cross-linker selected to be activated to chemically react with one or more polymers of the plurality of polymers, at a temperature in a predetermined range of temperatures.

69. The security device of claim 68, wherein a first polymer of the plurality of polymers of the adhesive exhibits tackification and solvent resistance.

70. The security device of claim 69, wherein the first polymer of the plurality of polymers of the adhesive does not exhibit resistance to aqueous agents.

71. The security device of claim 68, wherein a first polymer of the plurality of polymers of the adhesive exhibits resistance to aqueous agents and solvent resistance.

72. The security device of claim 71, wherein the first polymer of the plurality of polymers of the adhesive does not exhibit tackification.

73. The security device of claim 68, further comprising a third polymer of the adhesive, and wherein a first polymer of the plurality of polymers of the adhesive exhibits resistance to aqueous agents, a second polymer of the plurality of polymers of the adhesive exhibits solvent resistance, the third polymer of the plurality of polymers of the adhesive exhibits tackification, and the cross-linker is selected to be activated to chemically react with one or more of the first polymer, the second polymer, and the third polymer, at the temperature in the predetermined range of temperatures.

74. The security device of claim 68, wherein the adhesive layer has a thickness of 10 microns or less.

75. The security device of claim 68, wherein the adhesive layer has a thickness of 5 microns or less.

76. The security device of claim 68, wherein the adhesive exhibits wet tack from contact with a fibrous substrate containing sufficient water to activate a polymer of the plurality of polymers of the adhesive that exhibits tackification.

77. The security device of claim 68, wherein a polymer of the plurality of polymers of the adhesive that exhibits tackification comprises at least one of polyvinylpyrrolidone, carboxymethyl cellulose, guar, styrene butadiene rubber, Arabic gum or polyacrylic acid.

78. The security device of claim 68, wherein a polymer of the plurality of polymers of the adhesive that exhibits resistance to aqueous agents is provided as a solution, emulsion or dispersion in a liquid matrix.

79. The security device of claim 68, wherein a polymer of the plurality of polymers of the adhesive that exhibits solvent resistance comprises at least one of polyethylene, an ethylene copolymer, polypropylene, polytetrafluoroethylene, carboxymethyl cellulose or polyetheretherketone.

80. The security device of claim 68, wherein a polymer of the plurality of polymers of the adhesive that exhibits resistance to aqueous agents comprises at least one of polyvinylidene fluoride, polyethylene terephthalate, polyvinyl chloride, polyethylene, ethylene copolymers, polypropylene, polytetrafluoroethylene, polyurethane, or a copolymer of poly(vinyl acetate).

81. The security device of claim 68, wherein the temperature in the predetermined range of temperatures is greater than 100 degrees Celsius.

82. The security device of claim 68, wherein the temperature in the predetermined range of temperatures is between 65 and 100 degrees Celsius.

83. The security device of claim 68, wherein the adhesive further comprises a blocking agent which deactivates at the temperature in the predetermined range of temperatures.

84. The security device of claim 68, wherein the cross-linker comprises one or more of an aziridine, a carbodiimide, an isocyanate, a glutaraldehyde, glyoxal, glyoxylic acid or a salt thereof.

85. The security device of claim 68, wherein the cross-linker is selected to be activated to chemically react with a polymer of the plurality of polymers of the adhesive that exhibits tackification, at the temperature in the predetermined range of temperatures.

86. The security device of claim 68, wherein the cross-linker is selected to be activated to chemically react with a polymer of the plurality of polymers of the adhesive that exhibits solvent resistance, at the temperature in the predetermined range of temperatures.

87. The security device of claim 68, wherein the cross-linker is selected to be activated to chemically react with a polymer of the plurality of polymers of the adhesive that exhibits resistance to aqueous agents, at the temperature in the predetermined range of temperatures.

88. The security device of claim 68, wherein the cross-linker is selected to be activated to chemically react with one or more polymers of the plurality of polymers of the adhesive that collectively exhibit tackification and resistance to aqueous agents, at the temperature in the predetermined range of temperatures.

89. The security device of claim 68, wherein the cross-linker is selected to chemically react with each polymer of the plurality of polymers of the adhesive that collectively exhibit tackification, resistance to aqueous agents and solvent resistance, at or above the temperature in the predetermined range of temperatures.

90. The security device of claim 68, wherein the plurality of polymers of the adhesive does not include a single polymer which exhibits all three of tackification, solvent resistance and resistance to aqueous agents.

91. The security device of claim 68, wherein the security device comprises a continuous web to be applied as a security thread to a security document.

92. The security device of claim 68, wherein the authentication structure comprises a focusing layer.

93. The security device of claim 92, wherein the focusing layer comprises one or more of an array of refractive focusing elements or an array of reflective focusing elements.

94. The security device of claim 68, wherein the authentication structure produces a synthetic image.

95. The security device of claim 68, wherein the authentication structure comprises one or more of, a diffractive security device, a conductive trace, a circuit pattern, a wave guide, a negative space air lens, an insulating ceramic structure, an icon image element, microtext, an anti-reflective structure, a light refracting prism, a micro-mirror structure, a patterned metallization, an unpatterned metallization, a fluorescent security print, a ruled grating, a periodic array, an aperiodic array, a structure for increasing surface area or a tactility altering structure.
